(19) United States
(12) Patent Application Publication
(10) Pub. No.: US 2023/0344852 A1
(43) Pub. Date: Oct. 26, 2023

(54) CENTRALIZED TECHNIQUE TO MANAGE AN ENTERPRISE-LEVEL CYBERSECURITY MATURITY ASSESSMENT

(71) Applicant: Saudi Arabian Oil Company, Dhahran (SA)

(72) Inventors: Ahmad F. Sirhani, Dammam (SA); Eidan K. Eidan, Dhahran (SA); Abeer A. Shammari, Dhahran (SA); Mohammed M. Otaibi, Dammam (SA)

(21) Appl. No.: 17/660,109

(22) Filed: Apr. 21, 2022

(51) Int. Cl. H04L 9/40; G06Q 10/06

(52) U.S. Cl. CPC H04L 63/1433; G06Q 10/0635

(57) ABSTRACT

An automated method for centralized management of an enterprise-level cybersecurity maturity assessment includes (1) building a cybersecurity maturity assessment plan, (2) sending assessment questionnaires to subject matter experts (SMEs), (3) receiving completed questionnaires from the SMEs along with corresponding evidence artifacts relevant to the questionnaires; (4) sending the received questionnaires and corresponding artifacts to a cybersecurity maturity core team; (5) receiving verified and unverified questionnaires and corresponding artifacts sent to and analyzed by the core team; (6) repeating (2) through (5) for the unverified questionnaires and corresponding artifacts until the received questionnaires and corresponding artifacts are all verified; and (7) sending the verified questionnaires and corresponding artifacts to external assessors. Building the cybersecurity maturity assessment plan includes selecting cybersecurity categories by a cybersecurity category circuit trained by machine learning to classify cybersecurity incidents into corresponding incident types, and to evaluate the cybersecurity categories based on the classified incident types.

### FIELD OF THE DISCLOSURE

The present disclosure relates in general to information technology (IT) and information security, and more specifically to centralized techniques for managing enterprise-level cybersecurity maturity assessments.

### BACKGROUND OF THE DISCLOSURE

A cybersecurity maturity assessment assesses business processes on cybersecurity aspects of an enterprise. The assessment evaluation that an enterprise (or organization within the enterprise) practices determines the maturity level at which the enterprise or organization stands. By indicating the organization's maturity in the areas concerned, the assessment enables stakeholders to identify strengths and areas of improvement. This helps the stakeholders prioritize what to do in order to reach higher maturity levels. Assessment activities used to assess the cybersecurity maturity of the enterprise can be highly involved and communication-intensive, requiring many documents and approvals to be undertaken by a large number of employees in the enterprise. For example, the assessment can involve the collection of thousands of documents to be reviewed, consolidated, and submitted to external assessors.

It is in regard to these and other problems in the art that the present disclosure is directed to provide a technical solution for effective centralized techniques for managing enterprise-level cybersecurity maturity assessments.

### SUMMARY OF THE DISCLOSURE

According to a first aspect of the disclosure, an automated method for centralized management of an enterprise-level cybersecurity maturity assessment is provided. The method comprises: (1) building, by a processing circuit, a cybersecurity maturity assessment plan for an enterprise, the plan comprising a plurality of selected cybersecurity categories, each category comprising a plurality of security controls relevant to the category and a member of a cybersecurity maturity core team for analyzing and verifying submitted questionnaires and corresponding artifacts for the category, each security control including an assessment questionnaire and a plurality of subject matter experts (SMEs) for assessing a maturity level of the enterprise for the security control in the category; (2) sending, from the processing circuit to each SME of each security control of each category, the assessment questionnaire for the security control in the category; (3) receiving, by the processing circuit from each SME of each security control of each category, the assessment questionnaire sent to and completed by the SME along with an evidence artifact relevant to the maturity level of the enterprise for the security control in the category; (4) sending, from the processing circuit to the core team member of each category, the received questionnaires and corresponding artifacts for each security control of the category; (5) receiving, by the processing circuit from the core team member of each category, verified and unverified questionnaires and corresponding artifacts sent to and analyzed by the core team member of the category; (6) repeating, by the processing circuit for the unverified questionnaires and corresponding artifacts of each category, steps (2) through (5) until the received questionnaires and corresponding artifacts from the core team member for the category are all verified; and (7) sending, by the processing circuit for each category, the verified questionnaires and corresponding artifacts of the category to external assessors. Building the cybersecurity maturity assessment plan comprises selecting, by a cybersecurity category circuit, the plurality of selected cybersecurity categories from among a set of possible cybersecurity categories, the cybersecurity category circuit being trained by machine learning to classify a log of cybersecurity incidents of the enterprise into corresponding incident types, and to evaluate each possible cybersecurity category for the enterprise based on the classified incident types.

In an embodiment consistent with the above, the method further comprises: (8) receiving, by the processing circuit from the external assessors, rejected questionnaires and corresponding artifacts sent to and reviewed by the external assessors; and (9) repeating, by the processing circuit for the rejected questionnaires and corresponding artifacts, steps (2) through (8) until no rejected questionnaires and corresponding artifacts are received from the external assessors.

In an embodiment consistent with the above, the method further comprises displaying, on display devices for the cybersecurity maturity core team, analytical reports and dashboards illustrating progress of the enterprise-level cybersecurity maturity assessment as measured by relative completion of steps (1) through (9) from logs and data of the enterprise-level cybersecurity maturity assessment collected at the processing circuit.

In an embodiment consistent with the above, the method further comprises displaying, on display devices for the cybersecurity maturity core team, analytical reports and dashboards illustrating progress of the enterprise-level cybersecurity maturity assessment as measured by relative completion of steps (1) through (7) from logs and data of the enterprise-level cybersecurity maturity assessment collected at the processing circuit.

In an embodiment consistent with the above, the method further comprises logging, by the processing circuit, all sending and receiving activities in order to create an audit trail of the enterprise-level cybersecurity maturity assessment.

In an embodiment consistent with the above, building the cybersecurity maturity assessment plan comprises for each category: receiving, by the processing circuit from the cybersecurity maturity core team, a name of the category, the plurality of security controls relevant to the category, the core team member for the category, and a weight for the category; and receiving, by the processing circuit from the core team member of the category for each security control of the category, the assessment questionnaire and the plurality of SMEs for the security control of the category.

In an embodiment consistent with the above, building the cybersecurity maturity assessment plan further comprises: sending, by the processing circuit to the external assessors, the built cybersecurity assessment plan for approval by the external assessors; and receiving, by the processing circuit from the external assessors, the approval for the built cybersecurity assessment plan.

According to another aspect of the disclosure, an automated system for centralized management of an enterprise-level cybersecurity maturity assessment is provided. The system comprises: a processing circuit; a cybersecurity category circuit; and a non-transitory storage device. The non-transitory storage device stores instructions thereon that, when executed by the processing circuit, cause the processing circuit to: (1) build a cybersecurity maturity assessment plan for an enterprise, the plan comprising a plurality of selected cybersecurity categories, each category comprising a plurality of security controls relevant to the category and a member of a cybersecurity maturity core team for analyzing and verifying submitted questionnaires and corresponding artifacts for the category, each security control including an assessment questionnaire and a plurality of subject matter experts (SMEs) for assessing a maturity level of the enterprise for the security control in the category; (2) send, to each SME of each security control of each category, the assessment questionnaire for the security control in the category; (3) receive, from each SME of each security control of each category, the assessment questionnaire sent to and completed by the SME along with an evidence artifact relevant to the maturity level of the enterprise for the security control in the category; (4) send, to the core team member of each category, the received questionnaires and corresponding artifacts for each security control of the category; (5) receive, from the core team member of each category, verified and unverified questionnaires and corresponding artifacts sent to and analyzed by the core team member of the category; (6) repeat, for the unverified questionnaires and corresponding artifacts of each category, steps (2) through (5) until the received questionnaires and corresponding artifacts from the core team member for the category are all verified; and (7) send, for each category, the verified questionnaires and corresponding artifacts of the category to external assessors. Building the cybersecurity maturity assessment plan comprises selecting, by the cybersecurity category circuit, the plurality of selected cybersecurity categories from among a set of possible cybersecurity categories, the cybersecurity category circuit being trained by machine learning to classify a log of cybersecurity incidents of the enterprise into corresponding incident types, and to evaluate each possible cybersecurity category for the enterprise based on the classified incident types.

In an embodiment consistent with the system described above, the instructions, when executed by the processing circuit, further cause the processing circuit to: (8) receive, from the external assessors, rejected questionnaires and corresponding artifacts sent to and reviewed by the external assessors; and (9) repeat, for the rejected questionnaires and corresponding artifacts, steps (2) through (8) until no rejected questionnaires and corresponding artifacts are received from the external assessors.

In an embodiment consistent with the system described above, the instructions, when executed by the processing circuit, further cause the processing circuit to control, on display devices for the cybersecurity maturity core team, a display of analytical reports and dashboards illustrating progress of the enterprise-level cybersecurity maturity assessment as measured by relative completion of steps (1) through (9) from logs and data of the enterprise-level cybersecurity maturity assessment collected at the processing circuit.

In an embodiment consistent with the system described above, the instructions, when executed by the processing circuit, further cause the processing circuit to control, on display devices for the cybersecurity maturity core team, a display of analytical reports and dashboards illustrating progress of the enterprise-level cybersecurity maturity assessment as measured by relative completion of steps (1) through (7) from logs and data of the enterprise-level cybersecurity maturity assessment collected at the processing circuit.

In an embodiment consistent with the system described above, the instructions, when executed by the processing circuit, further cause the processing circuit to log all sending and receiving activities in order to create an audit trail of the enterprise-level cybersecurity maturity assessment.

In an embodiment consistent with the system described above, the instructions, when executed by the processing circuit, cause the processing circuit to build the cybersecurity maturity assessment plan by: receiving, from the cybersecurity maturity core team, a name of the category, the plurality of security controls relevant to the category, the core team member for the category, and a weight for the category; and receiving, from the core team member of the category for each security control of the category, the assessment questionnaire and the plurality of SMEs for the security control of the category.

In an embodiment consistent with the system described above, the instructions, when executed by the processing circuit, further cause the processing circuit to build the cybersecurity maturity assessment plan by: sending, to the external assessors, the built cybersecurity assessment plan for approval by the external assessors; and receiving, from the external assessors, the approval for the built cybersecurity assessment plan.

According to yet another aspect of the disclosure, a non-transitory computer readable medium (CRM) is provided. The CRM has computer instructions stored therein that, when executed by a processing circuit, cause the processing circuit to carry out an automated process of centralized management of an enterprise-level cybersecurity maturity assessment. The process comprises: (1) building a cybersecurity maturity assessment plan for an enterprise, the plan comprising a plurality of selected cybersecurity categories, each category comprising a plurality of security controls relevant to the category and a member of a cybersecurity maturity core team for analyzing and verifying submitted questionnaires and corresponding artifacts for the category, each security control including an assessment questionnaire and a plurality of subject matter experts (SMEs) for assessing a maturity level of the enterprise for the security control in the category; (2) sending, to each SME of each security control of each category, the assessment questionnaire for the security control in the category; (3) receiving, from each SME of each security control of each category, the assessment questionnaire sent to and completed by the SME along with an evidence artifact relevant to the maturity level of the enterprise for the security control in the category; (4) sending, to the core team member of each category, the received questionnaires and corresponding artifacts for each security control of the category; (5) receiving, from the core team member of each category, verified and unverified questionnaires and corresponding artifacts sent to and analyzed by the core team member of the category; (6) repeating, for the unverified questionnaires and corresponding artifacts of each category, steps (2) through (5) until the received questionnaires and corresponding artifacts from the core team member for the category are all verified; and (7) sending, for each category, the verified questionnaires and corresponding artifacts of the category to external assessors. Building the cybersecurity maturity assessment plan comprises selecting, by a cybersecurity category circuit, the plurality of selected cybersecurity categories from among a set of possible cybersecurity categories, the cybersecurity category circuit being trained by machine learning to classify a log of cybersecurity incidents of the enterprise into corresponding incident types, and to evaluate each possible cybersecurity category for the enterprise based on the classified incident types.

In an embodiment consistent with the CRM described above, the process further comprises: (8) receiving, from the external assessors, rejected questionnaires and corresponding artifacts sent to and reviewed by the external assessors; and (9) repeating, for the rejected questionnaires and corresponding artifacts, steps (2) through (8) until no rejected questionnaires and corresponding artifacts are received from the external assessors.

In an embodiment consistent with the CRM described above, the process further comprises controlling, on display devices for the cybersecurity maturity core team, a display of analytical reports and dashboards illustrating progress of the enterprise-level cybersecurity maturity assessment as measured by relative completion of steps (1) through (9) from logs and data of the enterprise-level cybersecurity maturity assessment collected at the processing circuit.

In an embodiment consistent with the CRM described above, the process further comprises controlling, on display devices for the cybersecurity maturity core team, a display of analytical reports and dashboards illustrating progress of the enterprise-level cybersecurity maturity assessment as measured by relative completion of steps (1) through (7) from logs and data of the enterprise-level cybersecurity maturity assessment collected at the processing circuit.

In an embodiment consistent with the CRM described above, the process further comprises logging all sending and receiving activities in order to create an audit trail of the enterprise-level cybersecurity maturity assessment.

In an embodiment consistent with the CRM described above, building the cybersecurity maturity assessment plan comprises: for each category, receiving, from the cybersecurity maturity core team, a name of the category, the plurality of security controls relevant to the category, the core team member for the category, and a weight for the category, and receiving, from the core team member of the category for each security control of the category, the assessment questionnaire and the plurality of SMEs for the security control of the category; sending, to the external assessors, the built cybersecurity assessment plan for approval by the external assessors; and receiving, from the external assessors, the approval for the built cybersecurity assessment plan.

Any combinations of the various embodiments and implementations disclosed herein can be used. These and other aspects and features can be appreciated from the following description of certain embodiments together with the accompanying drawings and claims.

### BRIEF DESCRIPTION OF THE DRAWINGS

FIG. 1 is a schematic diagram of an example automated system for centralized management of an enterprise-level cybersecurity maturity assessment, according to an embodiment.

FIG. 2 is a schematic diagram of an example technique for centralized management of an enterprise-level cybersecurity maturity assessment, according to an embodiment.

FIG. 3 is a flow diagram of an example automated method for building a cybersecurity maturity assessment plan for an enterprise, according to an embodiment.

FIG. 4 is a schematic diagram of an example automated system for centralized management of an enterprise-level cybersecurity maturity assessment, according to another embodiment.

FIG. 5 is a schematic diagram of an example automated process for centralized management of an enterprise-level cybersecurity maturity assessment, according to an embodiment.

FIG. 6 is a schematic diagram of an example machine learning use case, according to an embodiment.

FIG. 7 is a schematic diagram of an example machine learning use case, according to another embodiment.

FIG. 8 is a schematic diagram of an example machine learning use case, according to yet another embodiment.

FIGS. 9A-9B are flow diagrams of an example automated method for centralized management of an enterprise-level cybersecurity maturity assessment, according to an embodiment.

It is noted that the drawings are illustrative and not necessarily to scale, and that the same or similar features have the same or similar reference numerals throughout.

### DETAILED DESCRIPTION OF CERTAIN EMBODIMENTS OF THE DISCLOSURE

Example embodiments of the present disclosure are directed to automated centralized techniques for managing enterprise-level cybersecurity maturity assessments. Maturity assessment activities, such as subject matter experts (SMEs) filling out assessment questionnaires and providing documented evidence (also referred to as artifacts) to support the assessment questionnaires, are used to evaluate the enterprise's cybersecurity maturity. In an example method for centralized management of an enterprise-level cybersecurity maturity assessment, the method includes: managing artifacts submission by information technology (IT) SMEs; enabling a quality assurance process, analytical reports, and dashboards for verifying, consolidating, and reporting the artifacts collection; and collecting written feedback from the IT SMEs for each security control being assessed. In some embodiments, assessment questionnaires require SMEs to confirm implementation status of corresponding security controls commensurate with the cybersecurity maturity level being assessed.

Alternative approaches for performing enterprise-level cybersecurity maturity assessments include using email or shared electronic folders to carry out the shared documents and communication. However, this can become difficult to manage (or perhaps impossible or impractical) due to the substantial number/of submitted artifacts. For example, a typical assessment may generate over 2500 artifacts from over 20 separate information technology (IT) entities, and still have to be completed within a limited timeframe. In addition, it can be difficult to determine the proper assessment type (e.g., security controls and questionnaires to include) when the assessment platform is isolated from the actual data of the area of the organization that is being assessed.

It is in regard to these and other problems and challenges that embodiments of the present disclosure are directed to effective centralized techniques for managing enterprise-level cybersecurity maturity assessments. In some such embodiments, the techniques include integration with a machine learning platform trained to perform tasks such as function correlation, assessment score prediction, assessment questionnaire proposal, and assessment platform technical infrastructure management or optimization. It should be noted that the techniques described herein can be directed to the whole enterprise, or to one or more organizations (e.g., human resources, loss prevention, finance) within the enterprise. As such, for ease of description, the techniques will be described herein as if they are being directed to the whole enterprise unless the context indicates they are being directed to an organization within the enterprise. In addition, while the techniques herein are described with reference to cybersecurity maturity assessment, they are equally applicable to other IT maturity assessments that share similar frameworks (e.g., questionnaires, artifacts).

Some embodiments provide for a centralized technique for managing a cybersecurity maturity assessment via a collaborative computing platform running several processes. In addition, in order to get better information of the assessment content and assessed organization based on their historical assessment performance, in some embodiments, a machine learning platform is integrated with various systems within the enterprise. The machine learning platform gains knowledge and insight of the assessed area and of the infrastructure of the assessment platform in order to manage the computing appliances and software configurations for better utilization of these resources. Some embodiments are adaptive to any Information Technology, such as an entity who is responsible to conduct and manage cybersecurity maturity assessments to consolidate Information Technology entities' inputs and collect artifacts for external assessors' review and feedback.

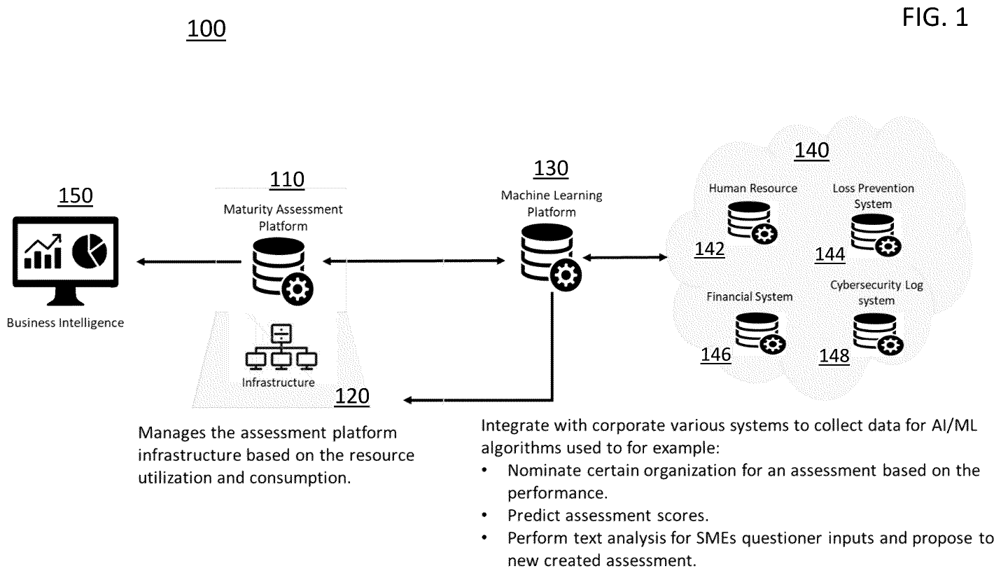

According to some embodiments, a centralized cybersecurity maturity assessment system is provided to collect large amounts of data and documents from many entities and involved participants. In some embodiments, a centralized platform manages an assessment at an enterprise level that requires inputs from several entities involving many subject matter experts. These and other embodiments will now be described with reference to FIGS. 1-9B.

FIG. 1 is a schematic diagram of an example automated system 100 for centralized management of an enterprise-level cybersecurity maturity assessment, according to an embodiment. FIG. 1 shows the integration of different components of an example assessment platform 110. In particular, the automated system 100 includes the maturity assessment platform 110 having an infrastructure 120, and a machine learning platform 130. FIG. 1 shows the integrated components of a cybersecurity maturity assessment platform.

The automated system 100 of FIG. 1 provides a centralized solution that manages a full cybersecurity maturity assessment of an enterprise via a collaborative platform and several processes. In addition, in order to get better information of the assessment content and assessed organization(s) based on their historical performance, the machine learning platform 130 is integrated with various systems within the enterprise. The machine learning platform 130 is further configured (e.g., programmed, trained) to gain knowledge and insight of the assessed areas as well as of the infrastructure of the assessment platform in order to better manage the various computing devices, appliances, and software configurations of the infrastructure 120 (e.g., to improve their utilizations and efficiencies).

In further detail, the maturity assessment platform 110 is a computing system (e.g., a standalone computer, a server computer, or the like, or portion thereof) configured (such as by code) to carry out the cybersecurity maturity assessment for an enterprise 140 or organization therein (e.g., human resources, loss prevention, finance). The maturity assessment platform 110 includes dedicated or shared computing components (e.g., processors, non-transitory storage devices) and networked infrastructure 120 programmed to perform the processes that make up the automated assessment.

The machine learning platform 130 can be the same (e.g., shared) or different computing resources configured (e.g., through machine learning techniques) to perform artificial intelligent tasks for the cybersecurity maturity assessment. The machine learning platform 130 integrates with the different organizations of the enterprise 140 (such as human resources 142, loss prevention system 144, financial system 146, and cybersecurity log system 148) to collect data (e.g., for training, categorizing, or otherwise acting on, such as for artificial intelligence or machine learning algorithms). These uses include: nominating a particular organization within the enterprise as the best candidate for a cybersecurity maturity assessment based on factors such as time since and performance on the last such assessment, predicting cybersecurity maturity assessment scores (e.g., based on past performance and current behavior), and performing text analysis for assisting the design or selection of SME questionnaires for new cybersecurity maturity assessment plans. The machine learning platform 130 is further trained to manage the assessment platform infrastructure 120. This includes monitoring computing resource utilization and consumption, and rebalancing resource loads to complete the cybersecurity maturity assessment more efficiently.

The maturity assessment platform 110 is further configured to communicate (e.g., over a computer network) the results of the cybersecurity maturity assessment and the machine learning platform 130 to the business intelligence 150 organization in the enterprise. Here, the results are analyzed in order to better allocate cybersecurity resources to, for example, improve weak areas of cybersecurity, identify the next organizations to assess cybersecurity maturity, and decide how much more computing resources to allocate to cybersecurity.

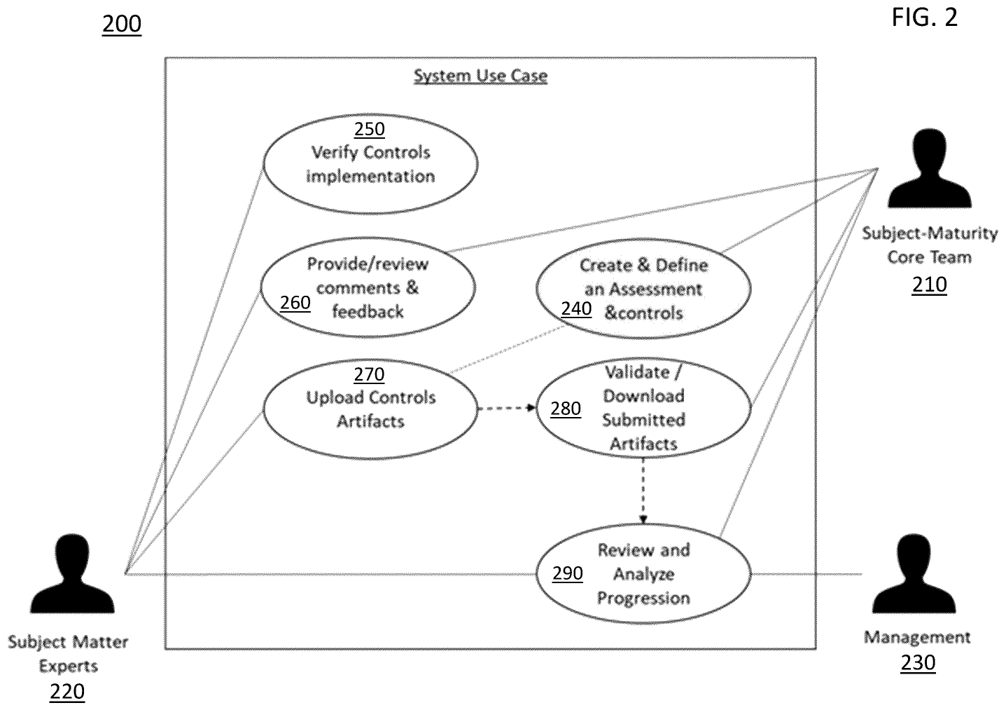

FIG. 2 is a schematic diagram of an example technique 200 for centralized management of an enterprise-level cybersecurity maturity assessment, according to an embodiment. FIG. 2 illustrates the flexibility concept of the assessment platform (such as maturity assessment platform 110 of FIG. 1) with the major components in association with the involved stakeholders (cybersecurity or subject maturity core team 210, subject matter experts 220, and management 230). Briefly, the technique 200 begins with the creation 240 of the cybersecurity maturity assessment plan, including defining the level of security controls and corresponding questionnaires used to carry out the assessment. The assessment plan is developed by the core team 210. Automation is used throughout the technique 200, with the assessment platform being programmed to carry out the tasks, from plan creation and approval to distribution, collection, and verification of the questionnaires and artifacts produced during the assessment.

In further detail, the cybersecurity maturity assessment is a bottoms-up approach to measuring the cybersecurity maturity of an enterprise (or organization within the enterprise). It is carried out by subject matter experts (SMEs) 220 familiar with the cybersecurity implementation practices of specific computing resources of the enterprise. Cybersecurity has been studied extensively, and its areas of exposure and best practices for addressing these exposures have been documented and organized into specific security controls, of which there are several hundred. While there are many ways to inquire from an SME 220 how a particular security control is being handled in their area of responsibility, for ease of description, the term “questionnaire” is used throughout to refer to such an inquiry or request (e.g., self-assessment, assessment of their area of responsibility) to an SME 220 for information pertinent to the maturity level of the enterprise in a particular security control that the SME 220 is competent to assess.

With this in mind, the core team 210 creates 240 the assessment plan, identifying the security controls that make up the plan, the corresponding SMEs 220 that can assess the security controls, and the corresponding questionnaires that will be used in the SMEs' assessments. Management 230 reviews and approves the assessment plan. The plan is then carried out, with the assessment platform being programmed to send the questionnaires to the corresponding SMEs 220 for each security control being assessed. Each SME 220 receives and responds to each questionnaire sent to them, including verifying 250 the security control implementation for their area of responsibility corresponds to that identified in the questionnaire. In addition, each SME 220 provides 260 comments and feedback in the questionnaire response, for review by the core team 210 as part of the assessment. Further, for each completed questionnaire, the corresponding SME 220 also uploads 270 an artifact or artifacts (e.g., evidence documents) that substantiate the responses put forth in the completed questionnaire and are relevant to the maturity level of the corresponding security control being assessed by the SME 220.

The assessment platform is further configured (e.g., by code) to receive the completed questionnaires and corresponding uploaded artifacts from the SMEs 220 and send them to corresponding members of the core team 210 for review. The core team 210 validates 280 and downloads the submitted artifacts and completed questionnaires from the SMEs 220. Invalid questionnaires (e.g., incomplete, unsubstantiated, and the like) and invalid artifacts are returned to the corresponding SMEs 220 for further processing. To this end, the assessment platform is further configured to receive the invalid questionnaire responses and artifacts from their corresponding core team members 210, and send them back to their correspond SMEs 220 for further processing. This process is repeated until the core team 210 receives and validates all of the completed questionnaires and corresponding artifacts. It should be noted that while the term “send” and “receive” are used to refer to the communication of documents between stakeholders, in practice, the assessment platform could be programmed to maintain all of the copies of the questionnaires (completed or not) and artifacts (once uploaded), and further programmed to provide a user interface to the stakeholders that permits exchanging, notifying, validating, and updating of the documents without necessarily any physical or electronic transfer of the documents.

At this point, the validated questionnaires and artifacts are sent from the core team 210 to the management 230 for review and approval of the actual assessment. To this end, the assessment platform is further programmed to receive the validated (or verified) questionnaires and artifacts from the core team 210 members, and send them to the management 230. The management 230 reviews 290 and approves the validated questionnaires and corresponding artifacts, and rejects any questionnaires and corresponding artifacts that fail their review. To this end, the assessment platform is further programmed to receive the rejected questionnaires and corresponding artifacts from the management 230 and send them to their corresponding core team members 210, and repeat the entire process on these rejected questionnaires and corresponding artifacts until all of the questionnaires and artifacts are approved by the management 230.

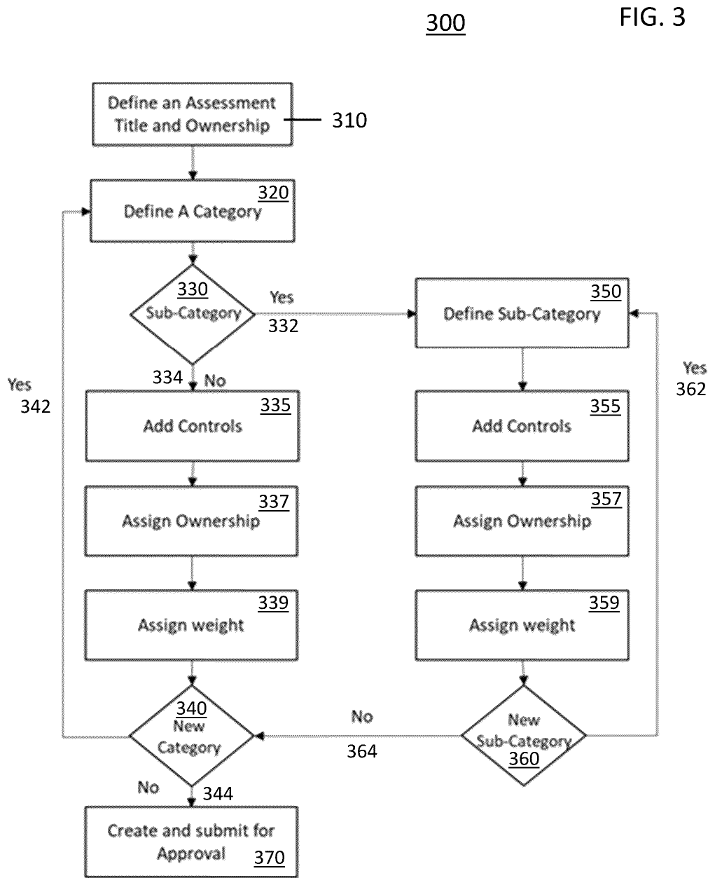

FIG. 3 is a flow diagram of an example automated method 300 for building a cybersecurity maturity assessment plan for an enterprise, according to an embodiment. As such, FIG. 3 shows the flow of an example process for defining and creating the assessment plan. The method 300 of FIG. 3 is intended to be performed on a computing or processing circuit that is configured (e.g., by code) to carry out the steps of the method 300 using information supplied by a cybersecurity maturity core team (such as subject-maturity core team 210).

Processing begins with the step of receiving 310 an assessment title and ownership information from the core team. The ownership includes a list of the members of the core team. Processing continues with the step of receiving 320 a name of a new category that makes up the assessment plan from the core team. For ease of implementation and administration, the assessment plan is broken up into categories (and each category possibly broken up into sub-categories), each category having its own set of security controls for assessing. The method 300 continues with the step of receiving 330 an indication from the core team whether there will be any sub-categories for the new category.

If no 334 (there will not be sub-categories), processing continues with the step of receiving 335 those security controls and corresponding questionnaires that make up the category from the core team. Processing further includes the step of receiving 337 assigned ownership of the category, including a core team member responsible for validating the assessment of the category and a list of SMEs (such as subject matter experts 220) for each security control for receiving and completing the corresponding questionnaire for the security control as part of the assessment. Processing then continues with the step of receiving 339 an assigned weight for the category from the core team. The weight provides a way to adjust the assessment score of the category when determining the contribution of the category assessment to the entire assessment. At this point, processing proceeds with the step of receiving 340 an indication from the core team whether there will be any further categories for the assessment. If yes 342 (there will be further categories), processing continues with repeating steps 320, 330, and either steps 335, 337, 339, and 340 (if no sub-categories) or steps 350, 357, 359, and 360 (if sub-categories) on the next category. If no 344 (no further categories), processing continues with the step of creating 370 and submitting the completed assessment plan for approval, such as by management (e.g., management 230) or external assessors.

If, on the other hand, the answer to the received indication in step 330 is yes 332 (there will be sub-categories), processing continues with the step of receiving 350 a name of a first sub-category for the category from the core team. In addition, processing includes the step of receiving 355 those security controls and corresponding questionnaires that make up the sub-category from the core team. Processing further includes the step of receiving 357 assigned ownership of the sub-category, including a core team member responsible for validating the assessment of the sub-category and a list of SMEs for each security control for receiving and completing the corresponding questionnaire for the security control as part of the assessment. Processing then continues with the step of receiving 359 an assigned weight for the sub-category from the core team. The weight provides a way to adjust the assessment score of the sub-category when determining the contribution of the sub-category assessment to the entire assessment. At this point, processing proceeds with the step of receiving 360 an indication from the core team whether there will be any further sub-categories for the category. If yes 362 (there will be further sub-categories), processing continues with repeating steps 350, 355, 357, 359, and 360 on the next sub-category. If no 364 (no further sub-categories), processing continues with the step of receiving 340 an indication from the core team whether there will be any further categories for the assessment as described above.

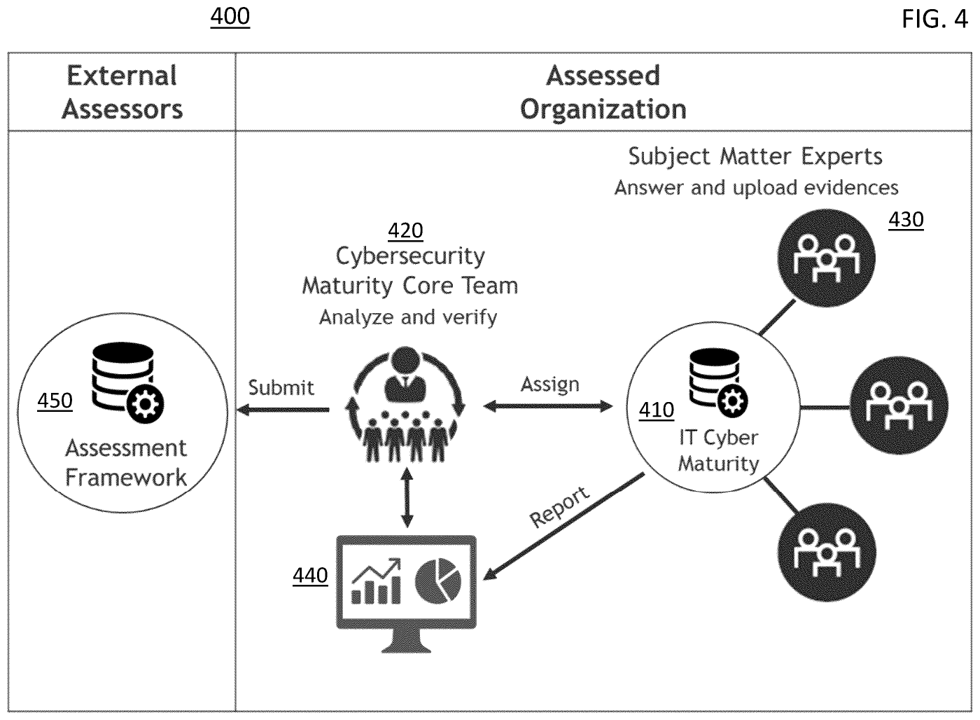

FIG. 4 is a schematic diagram of an example automated system 400 for centralized management of an enterprise-level cybersecurity maturity assessment, according to another embodiment. FIG. 4 is an example of an assessment and how the system handles and manages the assessment from an assessed organization prospective. The system 400 includes an IT cybersecurity maturity assessment platform 410 that sits between a cybersecurity maturity core team 420 who are reviewing and validating submittals (e.g., questionnaires and corresponding evidences or artifacts) from subject matter experts 430. In addition, the assessment platform 410 is configured (e.g., by code) to generate and display reports and dashboards (e.g., from collected logs and data, to describe or illustrate assessment progress) on display devices 440 for viewing by members of the core team 420. Further, the assessment platform 410 is programmed to submit the analyzed and verified questionnaires and artifacts from the core team 420 to an assessment framework platform 450 for review and audit by external assessors.

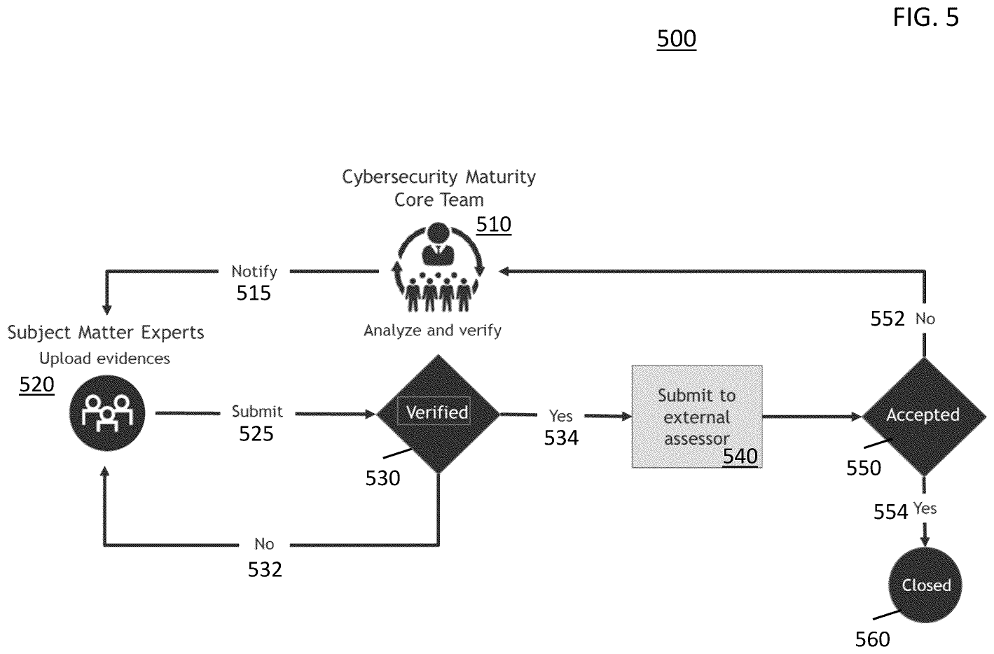

FIG. 5 is a schematic diagram of an example automated process 500 for centralized management of an enterprise-level cybersecurity maturity assessment, according to an embodiment. FIG. 5 shows one of the major processes to validate all inputs collected from IT entities being assessed. The process 500 ensures the participant inputs (from subject matter experts 520) are being reviewed and approved (by a cybersecurity maturity core team 510) before they get submitted to external assessors 540 while all activities are logged for audit trail purposes.

In further detail, an assessment platform (such as a cybersecurity maturity assessment circuit or other computing device) is programmed or otherwise configured (such as with custom logic) to carry out the process 500. The process 500 involves a communication and coordination between the cybersecurity maturity core team 510, the subject matter experts (SMEs) 520, and the external assessors 540 as controlled by the assessment platform. The process 500 includes receiving completed questionnaires and corresponding artifacts submitted 525 by the SMEs 520, which are analyzed 530 and verified by the core team 510, The process 500 further includes receiving the unverified questionnaires and artifacts from the core team 510 and sending 532 them back to their corresponding SMEs 520 for further processing and resubmission 525. After all the completed questionnaires and corresponding artifacts are verified 530, the process 500 further includes sending 534 the verified questionnaires and artifacts to the external assessors 540. The external assessors 540 review 550 the verified questionnaires and artifacts, accepting 554 some and rejecting 552 others. The process 500 includes receiving 552 the rejected questionnaires and artifacts and sending them to the core team 510 for further processing. The core team in turn notifies 515 (e.g., through the assessment platform) the corresponding SMEs 520 of their rejected questionnaires and artifacts. The entire process 500 is then repeated on the rejected questionnaires and artifacts until the external assessors 540 accept all of the verified questionnaires and corresponding artifacts, at which point the assessment is closed 560.

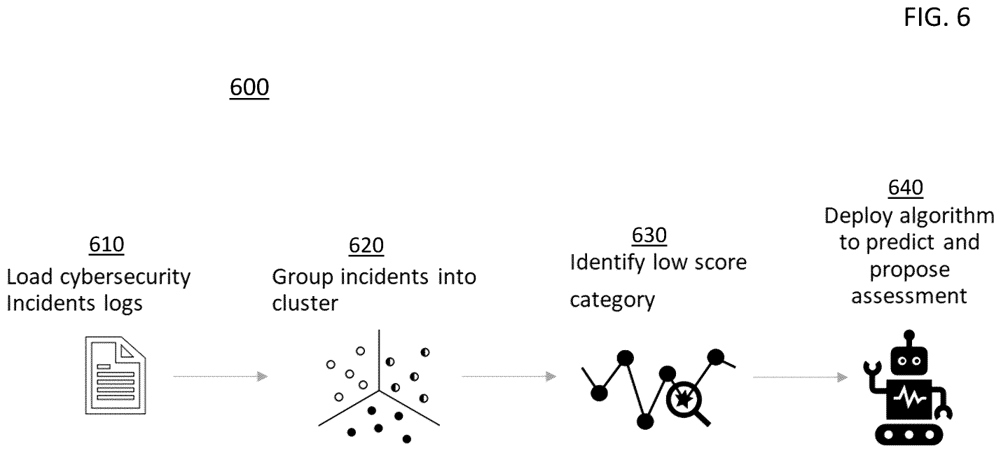

FIGS. 6-8 illustrate example machine learning use cases that could be part of integrated cybersecurity maturity assessment platforms, such as those described herein.

FIG. 6 is a schematic diagram of an example machine learning use case 600, according to an embodiment. Here, a cybersecurity maturity assessment platform is configured (e.g., by code) to perform a cybersecurity (or similar) maturity assessment for an organization. For example, the cybersecurity maturity assessment framework may address many aspects or categories of cybersecurity such as risk governance, access control, and vulnerability management. To this end, a machine learning platform (e.g., machine learning platform 130, such as an artificial neural network, a support-vector machine, or the like) is trained (such as by supervised training on training date built by SMEs and cybersecurity experts) to classify cybersecurity incidents (e.g., as collected in the cybersecurity log system 148) into cybersecurity incident types. The machine learning platform is further trained to evaluate (e.g., score) different cybersecurity categories based on the classified incident types. For instance, the training data can include sets of incident types (as determined by experts) and corresponding cybersecurity categories triggered by the incident types (again, as determined by experts).

With reference to FIG. 6, processing begins with the step of loading 610 cybersecurity incidents logs (e.g., collections of cybersecurity incidents, such as identified by information technology (IT) professionals, cybersecurity experts, and/or automated reporting techniques). For instance, the incidents logs can be retrieved daily, and used to train the machine learning platform (or to be classified by the trained machine learning platform) into corresponding cybersecurity incident types. For instance, the machine learning platform can be trained (e.g., through supervised learning techniques) to perform the step of grouping 620 the different incidents into clusters (where each cluster represents a different incident type).

The machine learning circuit can be further trained to evaluate (e.g., score) different cybersecurity categories based on signature patterns of the identified or classified incident types. To this end, the machine learning platform can be trained to perform the step of identifying 630 low scoring categories (e.g., those categories being associated most frequently with the identified or classified incident types). For instance, the machine learning platform can use the classified incident types and evaluated categories to perform the step of predicting 640 the weakest cybersecurity categories of an organization and proposing a corresponding cybersecurity assessment (e.g., set of selected cybersecurity categories) on which to perform a cybersecurity maturity assessment.

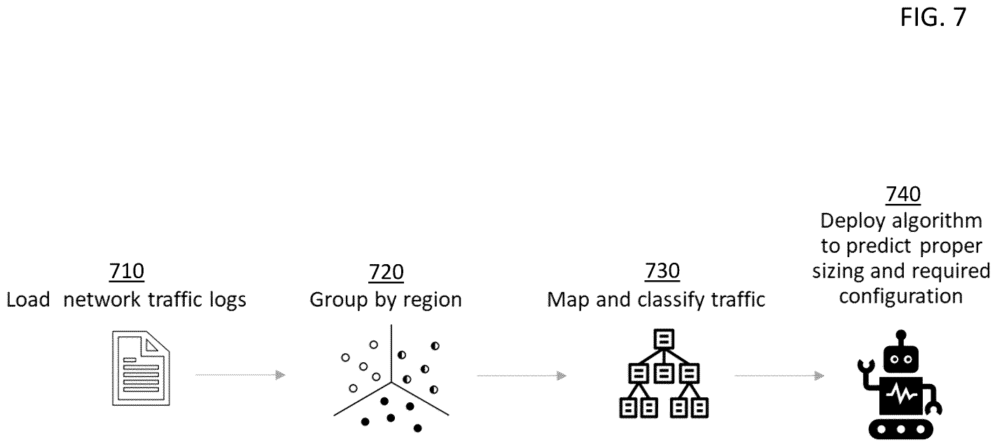

FIG. 7 is a schematic diagram of an example machine learning use case 700, according to another embodiment. The techniques discussed above in the cybersecurity assessment use case 600 of FIG. 6 can also be applied to other assessment situations. In FIG. 7, a platform infrastructure management/optimization perspective is used. Here, a machine learning model is developed (e.g., trained) to retrieve 710 network daily traffic logs in order to train the model (e.g., through supervised learning) on the traffic load and grouping 720 the network traffic by region in order to determine from where most of the traffic is coming (e.g., to map and classify 730 the traffic by various characteristics, such as source, type, or size). As a result, the machine learning platform can be used to help manage 740 the resources and balance the load to optimize the platform performance (e.g., through predicting accurate sizing requirements and reconfiguring resource allocations accordingly).

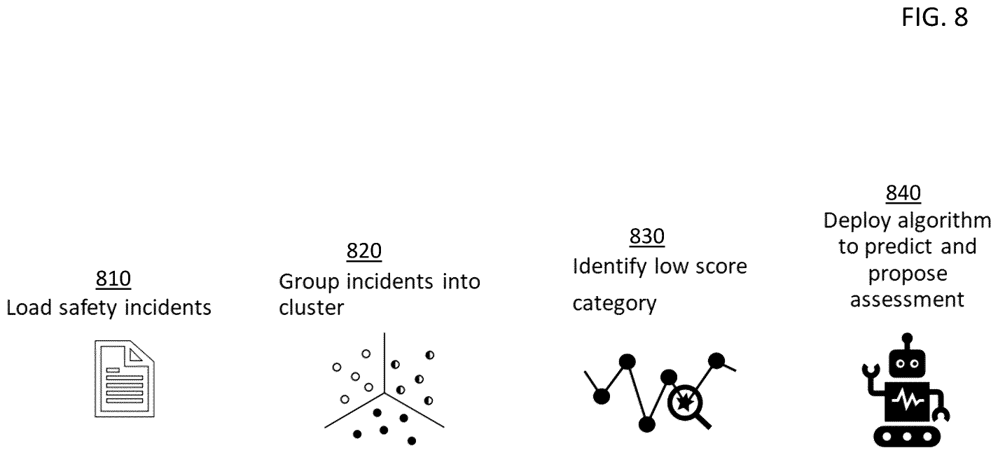

FIG. 8 is a schematic diagram of an example machine learning use case 800, according to yet another embodiment. Here, the machine learning platform is trained and used similarly to that of the cybersecurity maturity assessment use case 600 of FIG. 6, only it is directed to doing a safety maturity assessment (e.g., to predict and improve safety performance, such as accident reduction). That is, a model is developed (e.g., trained or deployed) to retrieve different types of daily recorded safety incidents and violations from loss prevention solutions in order to train the model on the prediction of organizations scores and pain areas on which the organization should conduct an assessment. In further detail, the machine learning platform can be configured by machine learning (along with some programming) to load 810 the accumulated safety incidents, group 820 or classify the incidents into clusters (e.g., safety incident types), identify 830 low scoring safety categories (e.g., as trained to score the possible safety categories from the classified incident types), and propose 840 a corresponding assessment plan (e.g., those safety categories most important to be part of the safety maturity assessment plan).

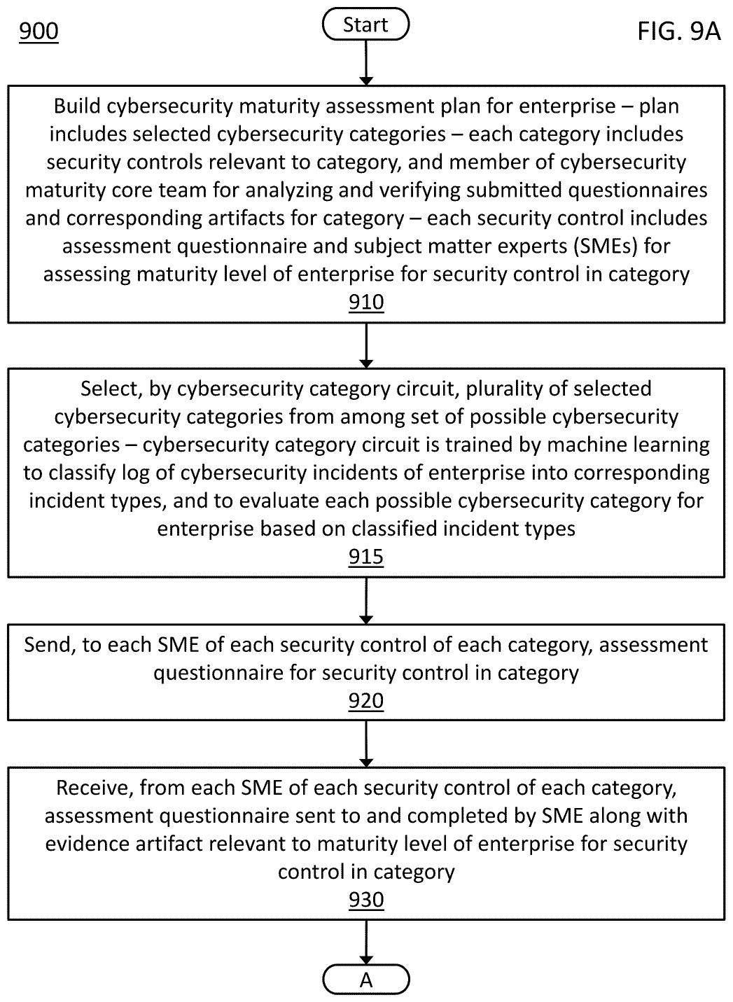

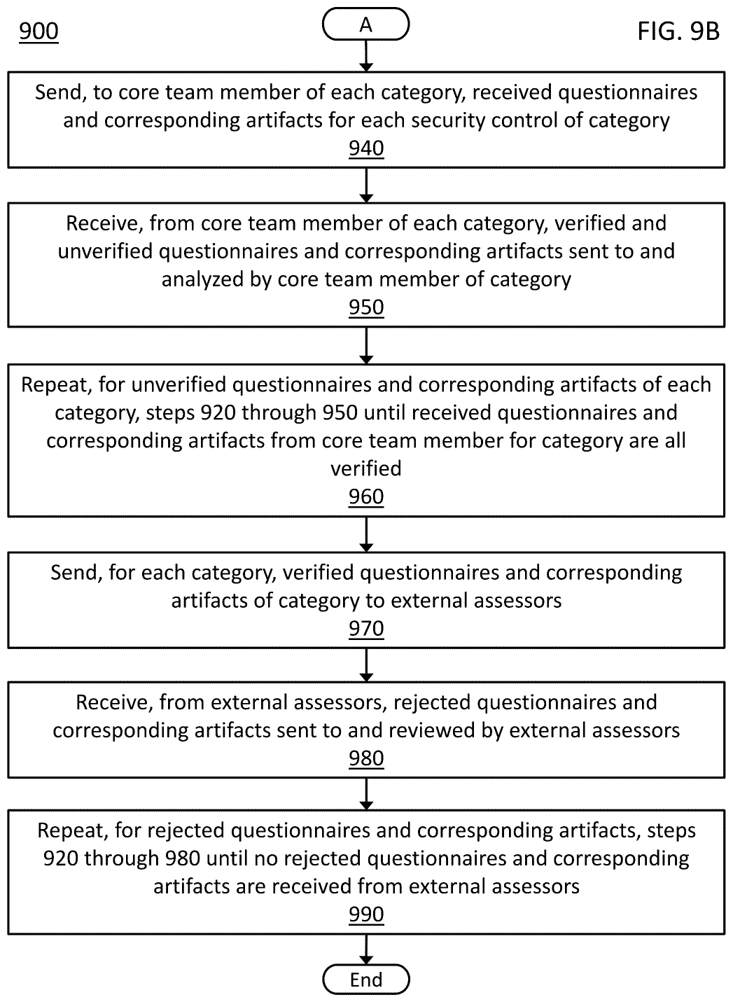

FIGS. 9A-9B are flow diagrams of an example automated method 900 for centralized management of an enterprise-level cybersecurity maturity assessment, according to an embodiment. The method 900 can be performed by a cybersecurity maturity assessment circuit (e.g., microprocessor, custom logic) programmed or otherwise configured to perform the steps (such as assessment platform 110 or 410). Processing begins with the step of building 910 a cybersecurity maturity assessment plan for an enterprise. The plan includes a plurality of selected cybersecurity categories. Each category includes a plurality of security controls relevant to the category, and a member of a cybersecurity maturity core team (such as cybersecurity maturity core team 210, 420, or 510). The core team member analyzes and verifies submitted questionnaires and corresponding artifacts for the category. Each security control includes an assessment questionnaire and a plurality of subject matter experts (SMEs, such as SMEs 220, 430, or 520). The SMEs assess a maturity level of the enterprise for the security control in the category.

The step 910 of method 900 includes the step of selecting 915, by a cybersecurity category circuit (such as a dedicated processing core or circuit, or a shared component of the cybersecurity maturity assessment circuit), the plurality of selected cybersecurity categories from among a set of possible cybersecurity categories. Here, the cybersecurity category circuit is trained by machine learning (for example, as an artificial neural network, or a support-vector machine, to name a few) to classify a log of cybersecurity incidents (e.g., as collected by cybersecurity log system 148) of the enterprise into corresponding incident types, and to evaluate each possible cybersecurity category for the enterprise based on the classified incident types.

The method 900 further includes the step of sending 920, to each SME of each security control of each category, the assessment questionnaire for the security control in the category. After completing the questionnaires, the method 900 includes the step of receiving 930, from each SME of each security control of each category, the assessment questionnaire sent to and completed by the SME along with an evidence artifact relevant to the maturity level of the enterprise for the security control in the category. In addition, the method 900 includes the step of sending 940, to the core team member of each category, the received questionnaires and corresponding artifacts for each security control of the category. After analyzing the questionnaires and corresponding artifacts, the method 900 includes the step of receiving 950, from the core team member of each category, verified and unverified questionnaires and corresponding artifacts sent to and analyzed by the core team member of the category.

The method 900 further includes the step of repeating 960, for the unverified questionnaires and corresponding artifacts of each category, steps 920 through 950 until the received questionnaires and corresponding artifacts from the core team member for the category are all verified. After the questionnaires and artifacts are verified, the process 900 includes the step of sending 970, for each category, the verified questionnaires and corresponding artifacts of the category to external assessors (such as management 230 or external assessors 540). After reviewing the verified questionnaires and artifacts, the method 900 includes the step of receiving 980, from the external assessors, rejected questionnaires and corresponding artifacts sent to and reviewed by the external assessors. In addition, the method 900 includes the step of repeating 990, for the rejected questionnaires and corresponding artifacts, steps 920 through 980 until no rejected questionnaires and corresponding artifacts are received from the external assessors.

In an embodiment, the method 900 includes the step of displaying, on display devices (such as display devices 440) for the cybersecurity maturity core team, analytical reports and dashboards illustrating progress of the enterprise-level cybersecurity maturity assessment as measured by relative completion of steps 910 through 990 from collected logs and data of the enterprise-level cybersecurity maturity assessment. In an embodiment, the method 900 includes the step of logging all sending and receiving activities in order to create an audit trail of the enterprise-level cybersecurity maturity assessment.

In an embodiment, building the cybersecurity maturity assessment plan includes for each category: receiving, from the cybersecurity maturity core team, a name of the category, the plurality of security controls relevant to the category, the core team member for the category, and a weight for the category; and receiving, from the core team member of the category for each security control of the category, the assessment questionnaire and the plurality of SMEs for the security control of the category. In an embodiment, building the cybersecurity maturity assessment plan further includes: sending, to the external assessors, the built cybersecurity assessment plan for approval by the external assessors; and receiving, from the external assessors, the approval for the built cybersecurity assessment plan.

The different logic components (e.g., cybersecurity enhancement circuit, processing circuit) described throughout can be implemented in a variety of ways, including hardware (e.g., custom logic circuits), firmware (such as with customizable logic circuits), or software (e.g., computer instructions executable on a processing circuit such as an electronic processor or microprocessor). These components can include computing, control, or other logic circuits configured (e.g., programmed) to carry out their assigned tasks. In some example embodiments, their logic is implemented as computer code configured to be executed on a computing circuit (such as a microprocessor) to perform the steps that are part of the technique.

The automated methods described herein can be implemented by an electronic circuit configured (e.g., by code, such as programmed, by custom logic, as in configurable logic gates, or the like) to carry out the steps of the method. Some or all of the methods described herein can be performed using the components and techniques illustrated in FIGS. 1-9B. In addition, these methods disclosed herein can be performed on or using programmed logic, such as custom or preprogrammed control logic devices, circuits, or processors. Examples include a programmable logic circuit (PLC), computer, software, or other circuit (e.g., ASIC, FPGA) configured by code or logic to carry out their assigned task. The devices, circuits, or processors can also be, for example, dedicated or shared hardware devices (such as laptops, single board computers (SBCs), workstations, tablets, smartphones, part of a server, or dedicated hardware circuits, as in FPGAs or ASICs, or the like), or computer servers, or a portion of a server or computer system. The devices, circuits, or processors can include a non-transitory computer readable medium (CRM, such as read-only memory (ROM), flash drive, or disk drive) storing instructions that, when executed on one or more processors, cause these methods to be carried out.

Any of the methods described herein may, in corresponding embodiments, be reduced to a non-transitory computer readable medium (CRM, such as a disk drive or flash drive) having computer instructions stored therein that, when executed by a processing circuit, cause the processing circuit to carry out an automated process for performing the respective methods.

The methods described herein may be performed in whole or in part by software or firmware in machine readable form on a tangible (e.g., non-transitory) storage medium. For example, the software or firmware may be in the form of a computer program including computer program code adapted to perform some of the steps of any of the methods described herein when the program is run on a computer or suitable hardware device (e.g., FPGA), and where the computer program may be embodied on a computer readable medium. Examples of tangible storage media include computer storage devices having computer-readable media such as disks, thumb drives, flash memory, and the like, and do not include propagated signals. Propagated signals may be present in a tangible storage media, but propagated signals by themselves are not examples of tangible storage media. The software can be suitable for execution on a parallel processor or a serial processor such that the method steps may be carried out in any suitable order, or simultaneously.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It is further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to a viewer. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. An automated method for centralized management of an enterprise-level cybersecurity maturity assessment, the method comprising:
(1) building, by a processing circuit, a cybersecurity maturity assessment plan for an enterprise, the plan comprising a plurality of selected cybersecurity categories, each category comprising a plurality of security controls relevant to the category and a member of a cybersecurity maturity core team for analyzing and verifying submitted questionnaires and corresponding artifacts for the category, each security control including an assessment questionnaire and a plurality of subject matter experts (SMEs) for assessing a maturity level of the enterprise for the security control in the category;
(2) sending, from the processing circuit to each SME of each security control of each category, the assessment questionnaire for the security control in the category;
(3) receiving, by the processing circuit from each SME of each security control of each category, the assessment questionnaire sent to and completed by the SME along with an evidence artifact relevant to the maturity level of the enterprise for the security control in the category;
(4) sending, from the processing circuit to the core team member of each category, the received questionnaires and corresponding artifacts for each security control of the category;
(5) receiving, by the processing circuit from the core team member of each category, verified and unverified questionnaires and corresponding artifacts sent to and analyzed by the core team member of the category;
(6) repeating, by the processing circuit for the unverified questionnaires and corresponding artifacts of each category, steps (2) through (5) until the received questionnaires and corresponding artifacts from the core team member for the category are all verified; and
(7) sending, by the processing circuit for each category, the verified questionnaires and corresponding artifacts of the category to external assessors,
wherein building the cybersecurity maturity assessment plan comprises selecting, by a cybersecurity category circuit, the plurality of selected cybersecurity categories from among a set of possible cybersecurity categories, the cybersecurity category circuit being trained by machine learning to classify a log of cybersecurity incidents of the enterprise into corresponding incident types, and to evaluate each possible cybersecurity category for the enterprise based on the classified incident types.

2. The method of claim 1, further comprising:
(8) receiving, by the processing circuit from the external assessors, rejected questionnaires and corresponding artifacts sent to and reviewed by the external assessors; and
(9) repeating, by the processing circuit for the rejected questionnaires and corresponding artifacts, steps (2) through (8) until no rejected questionnaires and corresponding artifacts are received from the external assessors.

3. The method of claim 2, further comprising displaying, on display devices for the cybersecurity maturity core team, analytical reports and dashboards illustrating progress of the enterprise-level cybersecurity maturity assessment as measured by relative completion of steps (1) through (9) from logs and data of the enterprise-level cybersecurity maturity assessment collected at the processing circuit.

4. The method of claim 1, further comprising displaying, on display devices for the cybersecurity maturity core team, analytical reports and dashboards illustrating progress of the enterprise-level cybersecurity maturity assessment as measured by relative completion of steps (1) through (7) from logs and data of the enterprise-level cybersecurity maturity assessment collected at the processing circuit.

5. The method of claim 1, further comprising logging, by the processing circuit, all sending and receiving activities in order to create an audit trail of the enterprise-level cybersecurity maturity assessment.

6. The method of claim 1, wherein building the cybersecurity maturity assessment plan comprises for each category:
receiving, by the processing circuit from the cybersecurity maturity core team, a name of the category, the plurality of security controls relevant to the category, the core team member for the category, and a weight for the category; and
receiving, by the processing circuit from the core team member of the category for each security control of the category, the assessment questionnaire and the plurality of SMEs for the security control of the category.

7. The method of claim 6, wherein building the cybersecurity maturity assessment plan further comprises:
sending, by the processing circuit to the external assessors, the built cybersecurity assessment plan for approval by the external assessors; and
receiving, by the processing circuit from the external assessors, the approval for the built cybersecurity assessment plan.

8. An automated system for centralized management of an enterprise-level cybersecurity maturity assessment, the system comprising:
a processing circuit;
a cybersecurity category circuit; and
a non-transitory storage device storing instructions thereon that, when executed by the processing circuit, cause the processing circuit to:
(1) build a cybersecurity maturity assessment plan for an enterprise, the plan comprising a plurality of selected cybersecurity categories, each category comprising a plurality of security controls relevant to the category and a member of a cybersecurity maturity core team for analyzing and verifying submitted questionnaires and corresponding artifacts for the category, each security control including an assessment questionnaire and a plurality of subject matter experts (SMEs) for assessing a maturity level of the enterprise for the security control in the category;
(2) send, to each SME of each security control of each category, the assessment questionnaire for the security control in the category;
(3) receive, from each SME of each security control of each category, the assessment questionnaire sent to and completed by the SME along with an evidence artifact relevant to the maturity level of the enterprise for the security control in the category;
(4) send, to the core team member of each category, the received questionnaires and corresponding artifacts for each security control of the category;
(5) receive, from the core team member of each category, verified and unverified questionnaires and corresponding artifacts sent to and analyzed by the core team member of the category;
(6) repeat, for the unverified questionnaires and corresponding artifacts of each category, steps (2) through (5) until the received questionnaires and corresponding artifacts from the core team member for the category are all verified; and
(7) send, for each category, the verified questionnaires and corresponding artifacts of the category to external assessors,
wherein building the cybersecurity maturity assessment plan comprises selecting, by the cybersecurity category circuit, the plurality of selected cybersecurity categories from among a set of possible cybersecurity categories, the cybersecurity category circuit being trained by machine learning to classify a log of cybersecurity incidents of the enterprise into corresponding incident types, and to evaluate each possible cybersecurity category for the enterprise based on the classified incident types.

9. The system of claim 8, wherein the instructions, when executed by the processing circuit, further cause the processing circuit to:
(8) receive, from the external assessors, rejected questionnaires and corresponding artifacts sent to and reviewed by the external assessors; and
(9) repeat, for the rejected questionnaires and corresponding artifacts, steps (2) through (8) until no rejected questionnaires and corresponding artifacts are received from the external assessors.

10. The system of claim 9, wherein the instructions, when executed by the processing circuit, further cause the processing circuit to control, on display devices for the cybersecurity maturity core team, a display of analytical reports and dashboards illustrating progress of the enterprise-level cybersecurity maturity assessment as measured by relative completion of steps (1) through (9) from logs and data of the enterprise-level cybersecurity maturity assessment collected at the processing circuit.

11. The system of claim 8, wherein the instructions, when executed by the processing circuit, further cause the processing circuit to control, on display devices for the cybersecurity maturity core team, a display of analytical reports and dashboards illustrating progress of the enterprise-level cybersecurity maturity assessment as measured by relative completion of steps (1) through (7) from logs and data of the enterprise-level cybersecurity maturity assessment collected at the processing circuit.

12. The system of claim 8, wherein the instructions, when executed by the processing circuit, further cause the processing circuit to log all sending and receiving activities in order to create an audit trail of the enterprise-level cybersecurity maturity assessment.

13. The system of claim 8, wherein the instructions, when executed by the processing circuit, cause the processing circuit to build the cybersecurity maturity assessment plan by:
receiving, from the cybersecurity maturity core team, a name of the category, the plurality of security controls relevant to the category, the core team member for the category, and a weight for the category; and
receiving, from the core team member of the category for each security control of the category, the assessment questionnaire and the plurality of SMEs for the security control of the category.

14. The system of claim 13, wherein the instructions, when executed by the processing circuit, further cause the processing circuit to build the cybersecurity maturity assessment plan by:
sending, to the external assessors, the built cybersecurity assessment plan for approval by the external assessors; and
receiving, from the external assessors, the approval for the built cybersecurity assessment plan.

15. A non-transitory computer readable medium (CRM) having computer instructions stored therein that, when executed by a processing circuit, cause the processing circuit to carry out an automated process of centralized management of an enterprise-level cybersecurity maturity assessment, the process comprising:
(1) building a cybersecurity maturity assessment plan for an enterprise, the plan comprising a plurality of selected cybersecurity categories, each category comprising a plurality of security controls relevant to the category and a member of a cybersecurity maturity core team for analyzing and verifying submitted questionnaires and corresponding artifacts for the category, each security control including an assessment questionnaire and a plurality of subject matter experts (SMEs) for assessing a maturity level of the enterprise for the security control in the category;
(2) sending, to each SME of each security control of each category, the assessment questionnaire for the security control in the category;
(3) receiving, from each SME of each security control of each category, the assessment questionnaire sent to and completed by the SME along with an evidence artifact relevant to the maturity level of the enterprise for the security control in the category;
(4) sending, to the core team member of each category, the received questionnaires and corresponding artifacts for each security control of the category;
(5) receiving, from the core team member of each category, verified and unverified questionnaires and corresponding artifacts sent to and analyzed by the core team member of the category;
(6) repeating, for the unverified questionnaires and corresponding artifacts of each category, steps (2) through (5) until the received questionnaires and corresponding artifacts from the core team member for the category are all verified; and
(7) sending, for each category, the verified questionnaires and corresponding artifacts of the category to external assessors,
wherein building the cybersecurity maturity assessment plan comprises selecting, by a cybersecurity category circuit, the plurality of selected cybersecurity categories from among a set of possible cybersecurity categories, the cybersecurity category circuit being trained by machine learning to classify a log of cybersecurity incidents of the enterprise into corresponding incident types, and to evaluate each possible cybersecurity category for the enterprise based on the classified incident types.

16. The CRM of claim 15, wherein the process further comprises:
(8) receiving, from the external assessors, rejected questionnaires and corresponding artifacts sent to and reviewed by the external assessors; and
(9) repeating, for the rejected questionnaires and corresponding artifacts, steps (2) through (8) until no rejected questionnaires and corresponding artifacts are received from the external assessors.

17. The CRM of claim 16, wherein the process further comprises controlling, on display devices for the cybersecurity maturity core team, a display of analytical reports and dashboards illustrating progress of the enterprise-level cybersecurity maturity assessment as measured by relative completion of steps (1) through (9) from logs and data of the enterprise-level cybersecurity maturity assessment collected at the processing circuit.

18. The CRM of claim 15, wherein the process further comprises controlling, on display devices for the cybersecurity maturity core team, a display of analytical reports and dashboards illustrating progress of the enterprise-level cybersecurity maturity assessment as measured by relative completion of steps (1) through (7) from logs and data of the enterprise-level cybersecurity maturity assessment collected at the processing circuit.

19. The CRM of claim 15, wherein the process further comprises logging all sending and receiving activities in order to create an audit trail of the enterprise-level cybersecurity maturity assessment.

20. The CRM of claim 15, wherein building the cybersecurity maturity assessment plan comprises:
for each category,
receiving, from the cybersecurity maturity core team, a name of the category, the plurality of security controls relevant to the category, the core team member for the category, and a weight for the category, and
receiving, from the core team member of the category for each security control of the category, the assessment questionnaire and the plurality of SMEs for the security control of the category;
sending, to the external assessors, the built cybersecurity assessment plan for approval by the external assessors; and
receiving, from the external assessors, the approval for the built cybersecurity assessment plan.
